(19) United States
(12) Patent Application Publication
(10) Pub. No.: US 2008/0166658 A1
(43) Pub. Date: Jul. 10, 2008

(54) Polyester film for flexographic printing plate

(75) Inventors: Sang Pil Kim, Gumi-si (KR); Ki Bong Suh, Gumi-si (KR); Chang Ik Hwang, Dalseo-gu (KR); Kyu Suk Lee, Dalseo-gu (KR)

Correspondence Address: D. PETER HOCHBERG CO. L.P.A., 1940 EAST 6TH STREET, CLEVELAND, OH, 44114, US

(73) Assignee: Toray Saehan Inc., A corporation of The Republic of Korea, Gumi-city (KR)

(21) Appl. No.: 11/800,872

(22) Filed: May 8, 2007

(30) Foreign Application Priority Data
Jan. 4, 2007 (KR) 2007-00952

(51) Int. Cl. G03C 1/76

(52) U.S. Cl. 430/271.1

(57) ABSTRACT

Disclosed herein is a polyester film for flexographic printing plates, which comprises: a polyester base layer (B); a detachable adhesive layer (A) formed on one surface of the polyester base layer using polyester resin and acrylic resin; and an antistatic layer (C) formed on the other surface of the polyester base layer. In the disclosed polyester film, the detachable adhesive layer is formed on one surface of the polyester base layer using polyester resin in combination with acrylic resin, and thus can have increased adhesion to the base layer and photosensitive resin. Also, the other surface of the polyester base layer has formed thereon the antistatic layer, which has excellent antistatic performance and, at the same time, is not transferred to a surface opposite thereto and is not greatly influenced by humidity. Thus, the disclosed polyester film is suitable for flexographic printing plates.

### BACKGROUND OF THE INVENTION

1. Field of the Invention

The present invention relates to a polyester film for flexographic printing plates, and more particularly to a polyester film suitable for flexographic printing plates, in which a detachable adhesive layer is formed on one surface of a polyester base layer using polyester resin in combination with acrylic resin so as to have increased adhesion to the base layer and photosensitive resin, and an antistatic layer is formed on the other surface of the polyester base layer, and thus has excellent antistatic performance and, at the same time, is not transferred to a surface opposite thereto and is not greatly influenced by humidity.

2. Background of the Related Art

A flexographic printing plate is manufactured by laminating photosensitive resin on one surface of a polyester base film through a coating or extrusion process, and additionally laminating a protective film for protecting the photosensitive resin, followed by aging. Then, the polyester base is exposed to UV light (back exposure) to secure the binding between the polyester base film and the photosensitive resin layer, and the protective film is then removed. Then, a negative film mask is formed on the photosensitive resin layer, and the photosensitive resin layer is exposed to UV light and developed with a solvent or heat. Finally, post-exposure is carried out, so that the stickiness of the photosensitive resin layer is removed and, at the same time, the photosensitive resin layer has print resistance. The manufactured rubber printing plate can be subjected to flexographic printing by mounting it on a flexographic printing roll using a double-sided adhesive tape formed on the surface of the polyester base.

The polyester film used as a base in the above process needs to have excellent adhesion to the photosensitive resin, and particularly should have excellent adhesion to the photosensitive resin layer even after completion of back exposure and post-exposure.

To improve the adhesion to the photosensitive resin, a coating layer is formed on one surface of the polyester base film using a coating material. However, in process conditions of high temperature and high humidity, the coating material can be peeled off from the polyester base film due to a reduction in adhesion to the polyester base film and due to binding to the photosensitive resin.

Also, the film should be transparent during the process such that the movement of light during light exposure cannot be refracted to increase resolution. Moreover, the film should have antistatic performance to minimize defects caused by foreign matter adhesion.

Also, the polyester base film for flexographic printing plates requires antistatic performance. Conventional polyester films are used in various applications, including photographs, drawings, OHP (over head projector), electrical/electronic parts, general industrial parts, and packing materials, due to excellent properties, including high mechanical properties, high heat resistance, high transparency, and chemical resistance.

However, such polyester films have disadvantages in that they have high intrinsic surface resistance and are well electrified by friction and the like. When the polyester film is electrified, a contaminant or dust is attached to the surface of the film, thus causing product failure.

Also, because electric discharge occurs during the production or processing of the film, the use of an organic solvent in the process causes the risk of catching fire. Thus, the polyester film for flexographic printing plates also requires antistatic treatment in order to prevent problems caused by the electrification of the film during processing.

Antistatic treatment methods known in the prior art include an internal addition method using organic sulfonate or organic phosphate, a method of depositing metal compounds, a method of applying conductive inorganic particles, and a method of applying anionic or cationic monomer compounds or polymer compounds.

However, the internal addition method using organic sulfonate or organic phosphate compounds is advantageous in that it has excellent aging or stability properties, but it reduces the inherent characteristics of the film support and has limitation on antistatic effects.

The method of depositing metal compounds and the method of applying conductive inorganic particles provide excellent antistatic performance, and thus have recently been frequently used for transparent conductive films. However, these methods cause a great increase in production cost, and thus are used only in specific applications.

On the other hand, the method of applying anionic or cationic monomer compounds or polymer compounds is widely used, because it has a relatively good antistatic effect and is advantageous in terms of production cost. However, it has shortcomings in that the film prepared according to this method highly depends on humidity, and particularly, in the case of an applied film roll, the antistatic agent is transferred to a surface opposite thereto.

Accordingly, the present inventors have made to improve properties suitable for a polyester film for flexographic printing plates, particularly to improve adhesion to photosensitive resin, and, as a result, prepared a polyester film in which a detachable adhesive layer is formed on one surface of a polyester base layer using polyester resin in combination with acrylic resin so as to have increased adhesion to the base layer and photosensitive resin, and an antistatic layer is formed on the other surface of the polyester base layer, and thus has excellent antistatic performance and, at the same time, is not transferred to a surface opposite thereto and is not greatly influenced by humidity, thereby accomplishing the present invention.

### SUMMARY OF THE INVENTION

It is an object of the present invention to provide a polyester film suitable for flexographic printing plates.

Another object of the present invention is to provide a polyester film suitable for flexographic printing plates, which comprises: a polyester base layer; a detachable adhesive layer formed on one surface of the polyester base layer and having excellent adhesion to photosensitive resin and the base layer; and an antistatic layer deposited on the other surface of the polyester base layer.

To achieve the above objects, the present invention provides a polyester film for flexographic printing plates, which comprises: a polyester base layer (B); a detachable adhesive layer (A) formed on one side of the polyester base layer using a coating solution containing polyester resin and acrylic resin; and an antistatic layer (C) formed on the opposite surface of the polyester base layer.

In the inventive polyester film for flexographic printing plates, the detachable adhesive layer (A) is formed by applying a coating solution prepared by dissolving, in purified water, 100 parts by weight of polyester resin, 30-200 parts of acrylic resin, 5-50 parts by weight of a crosslinking agent and 1.0-3.0 parts by weight of a surfactant.

In the inventive polyester film for flexographic printing plates, the antistatic layer (C) is formed by applying a coating solution prepared by dissolving, in purified water, 100 parts by weight of an antistatic agent consisting of quaternary ammonium copolymerized with an acrylic backbone, 3-30 parts by weight of a crosslinking agent and 1.0-3.0 parts by weight of a surfactant.

Herein, the crosslinking agent is at least one selected from the group consisting of melamine compounds, epoxy compounds, isocyanate compounds, carbonylimide compounds and oxazoline compounds.

### DETAILED DESCRIPTION OF THE PREFERRED EMBODIMENT

Hereinafter, the present invention will be described in detail.

The present invention provides a polyester film for flexographic printing plates, which comprises: a polyester base layer (B); a detachable adhesive layer (A) formed on one surface of the polyester base layer using a coating solution containing polyester resin and acrylic resin; and an antistatic layer (C) formed on the other surface of the polyester base layer using a coating solution containing an antistatic agent consisting of quaternary ammonium copolymerized with an acrylic backbone.

The detachable adhesive layer (A) in the present invention is formed by applying; to one surface of the polyester base layer (B), a coating solution consisting of acrylic resin, polyester resin, a crosslinking agent and a surfactant.

More specifically, the coating solution for forming the detachable adhesive layer (A) is prepared by dissolving 100 parts by weight of polyester resin, 30-200 parts by weight of acrylic resin, 5-50 parts by weight of a crosslinking agent and 1.0-3.0 parts by weight of a surfactant in purified water.

As the resin composition in the coating solution for forming the detachable adhesive layer (A), a combination of polyester resin and acrylic resin is used in order to increase adhesion to photosensitive resin and to increase adhesion to the polyester base film. Specifically, the detachable adhesive layer (A) in the present invention comprises a mixture of polyester resin and acrylic resin, and thus, a difference of surface energy between them occurs, so that the polyester resin increases adhesion to the polyester base layer (B), and the acrylic resin increases adhesion to photosensitive resin through UV light curing.

After the coating solution containing polyester resin in combination with acrylic resin is applied on the surface of the polyester film, it is subjected to a drying process during which the polyester resin having high surface energy is directed toward the base layer, the acrylic resin having relatively low surface energy is arranged as a surface layer, and thus a mixture layer consisting of polyester resin and acrylic resin is present between the two layers. In the above-described configuration, adhesion to the base can be increased through polyester resin, and adhesion to photosensitive resin can be increased through acrylic resin using subsequent UV light curing.

In the combination of polyester resin and acrylic resin, the acrylic resin is used in an amount of 30-200 parts by weight based on 100 parts by weight of the polyester resin.

If the acrylic resin is used in an amount of less than 30 parts by weight, adhesion to photosensitive resin through UV light curing will be insufficient, and if it is used in an amount of more than 200, it will reduce transparency.

To impart crosslinking density and solvent resistance to the resins, the coating solution for forming the detachable adhesive layer (A) contains at least one crosslinking agent selected from the group consisting of melamine compounds, epoxy compounds, isocyanate compounds, carbonylimide compounds and oxazoline compounds.

The crosslinking agent is preferably used in an amount of 5-50 parts by weight based on 100 parts by weight of the polyester resin. If the crosslinking agent is used in an amount of less than 5 parts by weight, the crosslinking degree of an interfacial layer between the polyester resin and the acrylic resin will be reduced, leading to a peeling phenomenon, and if it is used in an amount of more than 50 parts by weight, the coating surface will be non-uniform due to an increase in viscosity, and be brittle due to an excessive crosslinking effect, so that the coating surface will be easily peeled off.

Also, the surfactant in the coating solution for forming the detachable adhesive layer (A) according to the present invention is used to improve a leveling property in a coating process and is preferably used to 1.0-3.0 parts by weight based on 100 parts by weight of the polyester resin.

As the surfactant for use in the present invention, it is preferable to use any one selected from among nonionic surfactants, including polyoxyethylenealkylether, polyoxyethylene fatty acid ester, polyoxyethylenealkylphenolether, sorbitan fatty acid ester, polyoxyethylene sorbitan fatty acid ester, and sucrose fatty acid ester. If the content of the surfactant is lass than 1.0 part by weight, it will be difficult to form a uniform coating layer in a process of applying the coating solution, and if it exceeds 3.0 parts by weight, coating defects caused by bubbles resulting from the use of an excess amount of the surfactant will occur, and the adhesion between the acrylic resin layer and the photosensitive layer will be reduced.

The thickness of the detachable adhesive layer (A) according to the present invention is not specifically limited, but it is preferably applied to a thickness of 0.01-1 μm, and more preferably 0.02-0.5 μm. If the thickness of the detachable adhesive layer is smaller than 0.01 μm, the detachable adhesive layer will have good transparency, but will show reduced adhesion, and if the thickness is larger than 1 μm, the detachable adhesive layer will have good adhesion, but will show reduced transparency and coating properties, and blocking between the film surfaces can occur.

The antistatic layer (C) in the present invention is formed by applying, to the other surface of the polyester base layer (B), a coating solution consisting of an antistatic layer, a crosslinking agent and a surfactant.

Specifically, excellent antistatic performance is imparted to the polyester film by applying the coating solution for forming the antistatic layer (C) on the other surface of the polyester base layer (B), and the antistatic coating layer is not transferred to a surface opposite thereto and is not greatly influenced by humidity. Thus, a polyester film suitable for flexographic printing plates can be provided.

More specifically, the coating solution for forming the antistatic layer (C) is prepared by dissolving, in purified water, based on 100 parts by weight of the antistatic agent consisting of quaternary ammonium copolymerized with an acrylic backbone, 3-parts by weight of at least one crosslinking agent selected from the group consisting of melamine compounds, epoxy compounds, isocyanate compounds, carbonylimide compounds and oxazoline compounds, and 1.0-3.0 parts by weight of a surfactant.

The antistatic agent in the coating solution for forming the antistatic layer (C) according to the present invention consists of quaternary ammonium copolymerized with an acrylic backbone.

Specifically, the backbone of the antistatic agent is a copolymer of at least one selected from among methacrylate, butylacrylate, ethyl acrylate and acrylic acid, and the side chain thereof has quaternary ammonium salt such as dimethylaminoethylmethacrylate or glycidoxytrimethyl ammonium. The acrylic resin of the backbone contains a carboxyl group as a reactive functional group, so that it is crosslinked with a crosslinking agent such as a melamine compound or an epoxy compound, and thus can have excellent antistatic performance and excellent characteristics, including durability and water resistance. In addition, to increase the strength of the antistatic layer, a binder resin, such as acrylic resin, urethane resin or epoxy resin, which can react with a carboxyl group, may also additionally be added.

The crosslinking agent and the surfactant are the same as described for the detachable adhesive layer (A).

The thickness of the antistatic layer (C) according to the present invention is not specifically not limited, but the antistatic layer is preferably applied to a thickness of 0.01-1 μm, and more preferably 0.02-0.3 μm. If the thickness is smaller than 0.01 μm, the layer will not have sufficient antistatic performance, and if it is larger than 1 μm, the layer will excellent antistatic performance, but it will be difficult to form a uniform and transparent coating layer due to the use of an excess amount of the antistatic agent.

The polyester base layer (B) is a stretched film obtained by drying polyester resin in a vacuum, melting the resin with an extruder, extruding the melted resin through a T-die in the form of a sheet, attaching the sheet to a casting drum in a cooling roll by electrostatic pinning to cool and solidify the sheet so as to obtain an unstretched polyester sheet, longitudinally stretching the polyester film 2.5-4.5 times by a difference in velocity ratio between a roll and a roll in rolls heated to a temperature above the glass transition temperature of polyester resin, transversely stretching the film 3.0-7.0 times in a transverse stretching machine for mechanically stretching the film fixed by clips, and thermally fixing the stretched film.

The coating method using coating solution for forming the detachable adhesive layer (A), and coating solution for forming the antistatic layer (C), which is performed between longitudinally or transversely stretching process, is preferably carried out using a meyer bar coating method or a gravure coating method, but the present invention is not specifically limited thereto. Moreover, before the coating solutions are applied, it is also possible to introduce a polar group into the film surface and perform the corona discharge treatment of the film surface in order to improve the adhesion or coating properties between the coating layers and the film.

In the polyester film for flexographic printing plates according to the present invention, the detachable adhesive layer is formed on one surface of the polyester base layer (B) using acrylic resin in combination with polyester resin, and thus has improved adhesion to photosensitive resin and strong adhesion to the base layer (B). Also, the antistatic layer is formed on the other surface of the polyester base layer (B) using an antistatic agent consisting of quaternary ammonium copolymerized with on acrylic backbone, and thus has excellent antistatic performance, is not transferred to a surface opposite thereto, and is not greatly influenced by humidity.

Hereinafter, the present invention will be described in further detail with reference to examples. It is to be understood, however, that these examples are illustrative only, and the scope of the present invention is not limited thereto.

### EXAMPLE 1

1. Preparation of Coating Solution For Forming Detachable Adhesive Layer (A)

100 parts by weight (based on nonvolatile components) of water-dispersible polyester resin (produced by Nippon Synthesis Co.), 100 parts by weight of acrylic resin (produced by Nippon Carbide Co.), 10 parts by weight of a melamine-based crosslinking agent (produced by Cytec) and 2.5 parts by weight of nonionic acetylenic diol (Nissan Chemical Industries, Ltd.) as a surfactant were added to pure water passed through ion exchange resin, and the solution was stirred to prepare a coating solution. The coating solution had a total solid content of 3.0%.

2. Preparation of Coating Solution for Forming Antistatic Layer (C)

100 parts by weight of a cationic polymer antistatic agent consisting of quaternary ammonium salt copolymerized with the backbone of acrylic resin (produced by Konishi Co.), 2.5 parts by weight of 2.5 parts by weight of nonionic acetylenic diol (Nissan Chemical Industries, Ltd.) as a surfactant, and 5 parts by weight of epoxy resin (produced by Nagasechemtec, Co.) were added to pure water passed through ion exchange resin, and the solution was sufficiently stirred to prepare a coating solution. The coating solution had a total solid content of 3.0%.

3. Fabrication of Polyester Film for Flexographic Printing Plates

Polyethyleneterephthalate pellets having an intrinsic viscosity of 0.625 dl/g and containing 20 ppm of amorphous spherical silica particles having a mean particle diameter of 2.5 μm were sufficiently dried in a vacuum drier at 160° C. for 7 hours, and the dried pellets were melted, and stuck to a cooling drum through an extrusion die by electrostatic pinning to make a unstretched sheet. The unstretched sheet was heated again and stretched 3.5 times in the movement direction of the film at 100° C. to prepare a base film. After one surface of the prepared base film was subjected to corona discharge treatment, and the coating solution for forming a detachable adhesive layer (A) was applied on the corona discharge-treated surface using a meyer bar coating method (No. 5 wire bar) so as to form a detachable adhesive layer (A). The opposite surface of the base film formed the detachable adhesive layer was subjected to corona discharge treatment, and then the coating solution for forming the antistatic layer (C) was applied on the corona discharge-treated surface using a meyer bar coating method (No. 5 wire bar) so as to an antistatic layer (C). Then, the film was stretched 3.5 times in a direction perpendicular to the movement direction in the tender zone at 105-140° C., and then thermally treated at 240° C. for 4 seconds, thus obtaining a 175 μm thick polyester film for flexographic printing plates. Evaluation results for the polyester film are shown in Table 1 below.

### EXAMPLE 2

A polyester film for flexographic printing plates was fabricated in the same manner as in Example 1, except that, in the step of preparing the coating solution for forming a detachable adhesive layer (A), 100 parts by weight of polyester resin (produced by Nippon Synthesis Co.), 150 parts by weight of acrylic resin (produced by Nippon Carbide Co.), 20 parts by weight of an epoxy-based crosslinking agent (produced by Nagasechem Co.) and 1.5 parts by weight of nonionic acetylenic diol (produced by Nissan Chemical Industries, Ltd.) as a surfactant were added to pure water passed through ion exchange resin, and the solution was stirred to prepare a coating solution having a total solid content of 3.0%. Evaluation results for the polyester film are shown in Table 1 below.

### EXAMPLE 3

A polyester film for flexographic printing plates was fabricated in the same manner as in Example 1, except that, in the step of preparing the coating solution for forming a detachable adhesive layer (A), 30 parts by weight of melamine resin (produced by Cytec Corp) as a crosslinking agent was added. Evaluation results for the polyester film are shown in Table 1 below.

### COMPARATIVE EXAMPLE 1

A polyester film for flexographic printing plates was fabricated in the same manner as in Example 1, except that, in the step of preparing the coating solution for forming a detachable adhesive layer (A), 100 parts by weight (based on nonvolatile components) of acrylic resin (produced by Nippon Carbide Co.), 20 parts by weight of a melamine-based crosslinking agent (produced by Cytec Corp) and 1.5 parts by weight of nonionic acetylenic diol (Nissan Chemical Industries, Ltd.) as a surfactant were added to pure water passed through ion exchange resin and stirred to prepare a coating solution having a total solid content of 3.0%. Evaluation results for the polyester film are shown in Table 1 below.

### COMPARATIVE EXAMPLE 2

A polyester film for flexographic printing plates was fabricated in the same manner as in Example 1, except that, in the step of preparing the coating solution for forming a detachable adhesive layer (A), 100 parts by weight (based on nonvolatile components) of polyester resin (produced by Nippon Synthesis Co.), 25 parts by weight of a melamine-based crosslinking agent (produced by Cytec Corp) and 1.5 parts by weight of nonionic acetylenic diol (Nissan Chemical Industries, Ltd.) as a surfactant were added to pure water passed through ion exchange resin and stirred to prepare a coating solution having a total solid content of 3.0%. Evaluation results for the polyester film are shown in Table 1 below.

### COMPARATIVE EXAMPLE 3

A polyester film for flexographic printing plates was fabricated in the same manner as in Example 1, except that, in the step of preparing the coating solution for forming an antistatic layer (C), 100 parts by weight of quaternary ammonium salt (produced by Cytec Corp) as a low-molecular-weight cationic antistatic agent, 50 parts by weight of acrylic resin (produced by Nippon Carbide Co.), 2.5 parts by weight of nonionic acetylenic diol (Nissan Chemical Industries, Ltd.) as a surfactant and 10 parts by weight of epoxy resin (produced by Nagasechemtec Co.) as a crosslinking agent were added and stirred to prepare a coating solution having a total solid content of 3.0%. Evaluation results for the polyester film are shown in Table 1 below.

### EXPERIMENTAL EXAMPLE 1

The physical properties of the polyester films fabricated in Examples 1-3 and Comparative Examples 1-3 were measured in the following manner.

1. Surface Resistance and Humidity Dependency

Each of the films was left to stand for 24 hours in conditions of temperature of 25° C. and relative humidity of 60%, and then the surface resistance thereof was measured under an applied voltage of 500V using a surface resistance measurement device model R-503 (Kaoguchi Co., Japan). Also, the humidity dependence of each film was evaluated according to the following criteria on the basis of a difference in common log values of surface resistance values measured at humidity conditions of 40% and 85%.

Excellent: when surface resistance was less than 10¹¹ and a difference in common log values was less than 2; and

Poor: when surface resistance value was more than 10¹¹, or a difference in common log values was more than 2.

2. Transparency

The haze of each of the fabricated films was measured with an automatic digital hazemeter (Nippon Densoku Co., Japan), and differences from the haze of a non-treated film were classified according to the following criteria on the basis of a difference from the haze of a non-treated film. A lower variation in haze shows better transparency.

∘: less than 0.5%;

Δ: more than 0.5%, but less than 1.0%; and

x: more than 1.0%.

3. Adhesion

Adhesion was evaluated by laminating UV-curable photosensitive resin on the adhesive layer of each of the polyester films, preparing a 25 mm sample from the laminate, placing the sample in an Instron instrument and measuring a load applied when peeling between the photosensitive resin layer and the polyester layer occurred. The evaluation was performed before and after exposure to UV light.

⊚: no peeling between two layers;

∘: peeled off at more than 2.5 kg/25 mm;

Δ: peeled off at more than 1.0 kg/25 mm, but less than 2.5 kg/25 mm;

x: peeled off at less than 0.5 kg/25 mm.

4. Non-Transfer Ability

An adhesive tape (3M 610 tape) was attached to the surface of the antistatic layer, and detached from the surface. Then, adhesion occurring when the tape was attached to a clean steel plate and detached from the steel plate was evaluated. The non-transfer property of the film was evaluated according to the following criteria compared to the initial peeling force of the tape.

∘: a change in peeling force, which was more than 95% of initial peeling force;

Δ: a change in peeling force, which was 85-95% of initial peeling force; and

x: a change in peeling force, which was less than 85% of initial peeling force.

TABLE 1

| | Antistatic performance | | | | |
|---|---|---|---|---|---|
| | Surface | Humidity | | | Non-transfer |
| | resistance (Ω/□) | dependency | Transparency | Adhesion | properties |
| Example 1 | 3.2 × 10⁸ | Excellent | ◯ | ⊚ | ◯ |
| Example 2 | 3.4 × 10⁸ | Excellent | ◯ | ⊚ | ◯ |
| Example 3 | 2.1 × 10⁸ | Excellent | ◯ | ⊚ | ◯ |
| Comparative | 6.1 × 10⁸ | Excellent | ◯ | Δ | ◯ |
| Example 1 | | | | | |
| Comparative | 4.1 × 10⁸ | Excellent | ◯ | Δ | ◯ |
| Example 2 | | | | | |
| Comparative | 8.3 × 10¹² | Poor | X | Δ | X |
| Example 3 | | | | | |

As can be seen in Table 1 above, the polyester films fabricated in Examples 1 to 3 showed significantly excellent adhesion to the photosensitive resin compared to the films fabricated in Comparative Examples 1 to 3, and had a surface resistance value of 10⁸, indicating excellent antistatic performance. Also, the antistatic performance of the polyester films fabricated in Examples 1 to 3 was not greatly influenced by humidity, and the antistatic layer was not transferred to a surface opposite thereto. Moreover, the polyester film of the present invention has excellent transparency and does not refract the movement of light in an exposure process; therefore the resolution is increased, and thus is suitable for flexographic printing plates.

As described above, in the polyester film according to the present invention, polyester resin is used in combination with acrylic resin instead of using acrylic resin alone to form the detachable adhesive layer on one surface of the polyester base layer (B), so that the polyester resin increases adhesion to the base layer, and the acrylic resin increases adhesion to photosensitive resin. Thus, the polyester film for flexographic printing plates of the present invention has increased adhesion to photosensitive resin.

Also, the antistatic layer is formed on the opposite surface of the polyester base layer (B) using an antistatic agent consisting of quaternary ammonium copolymerized with an acrylic backbone, the polyester film for flexographic printing plates of the present invention has excellent antistatic performance and, at the same time, is not transferred to a surface opposite thereto and is not greatly influenced by humidity.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A polyester film for flexographic printing plates, which comprises:
a polyester base layer (B);
a detachable adhesive layer (A) formed on one surface of the polyester base layer using a coating solution containing polyester resin and acrylic resin; and
an antistatic layer (C) formed on the other surface of the polyester base layer.

2. The polyester film of claim 1, wherein the adhesive layer (A) is formed by applying a coating solution prepared by dissolving, in purified water, 100 parts by weight of polyester resin, 30-200 parts of acrylic resin, 5-50 parts by weight of a crosslinking agent and 1.0-3.0 parts by weight of a surfactant.

3. The polyester film of claim 1, wherein the antistatic layer (C) is formed by applying a coating solution prepared by dissolving, in purified water, 100 parts by weight of an antistatic agent consisting of quaternary ammonium copolymerized with an acrylic backbone, 3-30 parts by weight of a crosslinking agent and 1.0-3.0 parts by weight of a surfactant.

4. The polyester film of claim 3 or 4, wherein the crosslinking agent is at least one selected from the group consisting of melamine compounds, epoxy compounds, isocyanate compounds, carbonylimide compounds and oxazoline compounds.
